(19) United States
(12) Patent Application Publication
(10) Pub. No.: US 2013/0078732 A1
(43) Pub. Date: Mar. 28, 2013

(54) METHODS FOR DIAGNOSING IMPENDING JOINT FAILURE

(71) Applicants: Wendell Ray Guffey, Swansea, IL (US); Dennis Lawler, Ofallon, IL (US); Selena E. Richards, London (GB)

(72) Inventors: Wendell Ray Guffey, Swansea, IL (US); Dennis Lawler, Ofallon, IL (US); Selena E. Richards, London (GB)

(21) Appl. No.: 13/138,293

(22) PCT Filed: Jan. 29, 2010
(86) PCT No.: PCT/US10/00270

§ 371 Date: Jan. 18, 2012

Related U.S. Application Data
(60) Provisional application No. 61/206,640, filed on Feb. 2, 2009.

(51) Int. Cl. G01N 24/08

(52) U.S. Cl. CPC G01N 24/08
USPC 436/173; 422/82.01

(57) ABSTRACT

The invention provides methods for diagnosing impending joint failure in an animal by measuring the concentration of phenylalanine in a body fluid; measuring the concentration of one or more of tyrosine, alanine, valine, and glutamine in the body fluid; determining the ratio of phenylalanine to one or more of tyrosine, alanine, valine, and glutamine; and diagnosing impending joint failure by comparing the ratio to ratios predicative of impending joint failure.

### CROSS REFERENCE TO RELATED APPLICATIONS

This application is a national stage application under 35 U.S.C. §371 of PCT/US2010/000270 filed Jan. 29, 2010, which claims priority to U.S. Provisional Application Ser. No. 61/206,640 filed Feb. 2, 2009, the disclosures of which are incorporated herein by reference.

### BACKGROUND OF THE INVENTION

1. Field of the Invention

The invention relates generally to methods for diagnosing disease and particularly to methods for diagnosing impending joint failure.

2. Description of Related Art

Methods for diagnosing joint related conditions are known in the art. WO28049225A1 discloses methods for prognosing osteoarthritis by determining the cellular localization of pituitary homeobox transcription factor 1 (pitx-1) repressor protein or complex, e.g. prohibitin or prohibitone in a sample, e.g. articular chondrocytes sample. US20070248986A1 discloses methods for predicting the likelihood of developing rheumatoid arthritis for individuals with recent-onset undifferentiated arthritis by determining a set of clinical parameter values and a predicted risk for developing rheumatoid arthritis by correlating the parameter values with predefined risk values associated with ranges of parameter values, e.g., serum levels of C-reactive protein, Rheumatoid factors, anti-CCP antibodies, age, gender, localization of the joint complaints, length of morning stiffness, and number of tender and/or swollen joints. U.S. Pat. No. 7,005,274 discloses diagnostic methods for early detection of a risk for developing an arthritic disorder in humans and screening assays for therapeutic agents useful in the treatment of arthritic disorders by comparing the levels of one or more indicators of altered mitochondrial function, e.g., enzymes such as mitochondrial enzymes, ATP biosynthesis factors, mitochondrial mass, mitochondrial number, mitochondrial DNA content, cellular responses to elevated intracellular calcium and to apoptogens, and free radical production. US20040242987A1 discloses methods for predicting bone or articular disease affecting musculoskeletal system (e.g. osteoporosis) by obtaining micro and macro-structural or biomechanical parameters obtained from images of a joint and analyzing at least two of the parameters, e.g., macro anatomical parameters and biomechanical parameters. Other known methods include physical examination, plain film radiography, computed axial tomography (CAT) scans, magnetic resonance imaging (MRD scans, contrast radiography, and arthroscopy.

Diagnosing joint related conditions such as impending joint failure in animals using physical examination and plain film radiography is common. In particular, these methods are the primary tools for diagnosing osteoarthritis in various animals such as dogs. However, affected animals often do not exhibit overt lameness or other symptoms indicating impending joint failure. Unfortunately, this means that observable clinical signs are insufficient to support a presumptive diagnosis of impending joint failure, e.g., osteoarthritis. Further, plain film radiography, while it is the most frequently used screening technology, reveals bony changes but often does not demonstrate changes in soft tissues such as the joint capsule, thus complicating routine diagnosis. Similarly, CAT and MRI scans are expensive and often not widely available. Contrast radiography and arthroscopy add a degree of invasiveness. In some animals such as dogs, these additional modalities always require some form of restraint such as anesthesia, thus adding cost, complexity, and risk. Given these limitations to known methods, impending joint failure often goes undiagnosed. There is, therefore, a need for new methods for diagnosing impending joint failure in animals.

### SUMMARY OF THE INVENTION

It is, therefore, an object of the present invention to provide methods for diagnosing impending joint failure in animals.

It is another object of the invention to provide methods for determining the effect of an agent on an animal's prognosis for joint disease or joint failure.

It is a further object of the invention to provide methods for preventing or treating joint disease or failure in animals.

It is another object of the invention to provide means for communicating information about or instructions for diagnosing impending joint failure in animals.

It is another object of the invention to provide systems for diagnosing impending joint failure in animals.

It is a further object of the invention to provide computing devices useful for diagnosing impending joint failure in animals.

It is another object of the invention to provide software programs useful for diagnosing impending joint failure in animals.

It is another object of the present invention to provide methods for extending the healthy prime years of an animal's life.

It is another object of the present invention to provide methods for promoting the health or wellness of an animal.

One or more of these or other objects are achieved using methods for diagnosing impending joint failure in an animal by measuring the concentration of phenylalanine in a body fluid; measuring the concentration of one or more of tyrosine, alanine, valine, and glutamine in the body fluid; determining the ratio of phenylalanine to one or more of tyrosine, alanine, valine, and glutamine; and diagnosing impending joint failure when at least one of the phenylalanine:tyrosine ratio is equal to or greater than 0.2 but equal to or less than 0.8, the phenylalanine:alanine ratio is equal to or greater than 1.5 but equal to or less than 9.8, the phenylalanine:valine ratio is equal to or greater than 1.0 but equal to or less than 6.0, and the phenylalanine:glutamine ratio is equal to or greater than 0.5 but equal to or less than 4.5. When determining the effect of an agent on an animal's prognosis for joint disease or failure, animals are diagnosed using the above methods before and after the agent is administered and the results are compared to determine if the agent is likely to effect joint disease or failure.

Other and further objects, features, and advantages of the present invention will be readily apparent to those skilled in the art.

### DETAILED DESCRIPTION OF THE INVENTION

### Definitions

The term “joint” means a connection between two or more adjacent parts of an animal skeleton, whether bone or cartilage.

The term “joint failure” means a disease or other condition affecting a joint such that the joint requires therapeutic intervention, e.g., by physical therapy, surgery, holistic, medical, pharmacological, or other suitable intervention.

The term “animal” means any animal susceptible to or suffering from joint failure, including human, avian, bovine, canine, equine, feline, hicrine, lupine, murine, ovine, or porcine animals.

The term “companion animals” means domesticated animals such as dogs, cats, birds, rabbits, guinea pigs, ferrets, hamsters, mice, gerbils, pleasure horses, cows, goats, sheep, donkeys, pigs, and more exotic species kept by humans for company, amusement, psychological support, extrovert display, and all of the other functions that humans need to share with animals of other species.

The term “extending the prime” means extending the number of years an animal lives a healthy life and not just extending the number of years an animal lives, e.g., an animal would be healthy in the prime of its life for a relatively longer time.

The term “health and/or wellness of an animal” means the complete physical, mental, and social well being of the animal, not merely the absence of disease or infirmity.

As used herein, ranges are used herein in shorthand, so as to avoid having to list and describe each and every value within the range. Any appropriate value within the range can be selected, where appropriate, as the upper value, lower value, or the terminus of the range.

As used herein, the singular form of a word includes the plural, and vice versa, unless the context clearly dictates otherwise. Thus, the references “a”, “an”, and “the” are generally inclusive of the plurals of the respective terms. For example, reference to “a joint” or “a method” includes a plurality of such “joints” or “methods.” Similarly, the words “comprise”, “comprises”, and “comprising” are to be interpreted inclusively rather than exclusively. Likewise the terms “include”, “including” and “or” should all be construed to be inclusive, unless such a construction is clearly prohibited from the context.

The methods and compositions and other advances disclosed here are not limited to particular methodology, protocols, and reagents described herein because, as the skilled artisan will appreciate, they may vary. Further, the terminology used herein is for the purpose of describing particular embodiments only, and is not intended to, and does not, limit the scope of that which is disclosed or claimed.

Unless defined otherwise, all technical and scientific terms, terms of art, and acronyms used herein have the meanings commonly understood by one of ordinary skill in the art in the field(s) of the invention, or in the field(s) where the term is used. Although any compositions, methods, articles of manufacture, or other means or materials similar or equivalent to those described herein can be used in the practice of the present invention, the preferred compositions, methods, articles of manufacture, or other means or materials are described herein.

All patents, patent applications, publications, technical and/or scholarly articles, and other references cited or referred to herein are in their entirety incorporated herein by reference to the extent allowed by law. The discussion of those references is intended merely to summarize the assertions made therein. No admission is made that any such patents, patent applications, publications or references, or any portion thereof, are relevant, material, or prior art. The right to challenge the accuracy and pertinence of any assertion of such patents, patent applications, publications, and other references as relevant, material, or prior art is specifically reserved.

### The Invention

In one aspect, the invention provides methods for diagnosing impending joint failure in an animal. The methods comprise measuring the concentration of phenylalanine in a body fluid; measuring the concentration of one or more of tyrosine, alanine, valine, and glutamine in the body fluid; determining the ratio of phenylalanine to one or more of tyrosine, alanine, valine, and glutamine; and diagnosing impending joint failure when at least one of the phenylalanine:tyrosine ratio is equal to or greater than 0.2 but equal to or less than 0.8, the phenylalanine:alanine ratio is equal to or greater than 1.5 but equal to or less than 9.8, the phenylalanine:valine ratio is equal to or greater than 1.0 but equal to or less than 6.0, and the phenylalanine:glutamine ratio is equal to or greater than 0.5 but equal to or less than 4.5.

The invention is based upon the discovery that the ratio of the amounts of the amino acid phenylalanine to one or more of the amino acids and tyrosine, alanine, valine, and glutamine serves as a biochemical indicator for diagnosing impending joint failure by indicating or predicting the threshold for joint failure. The invention allows veterinary and other clinicians to perform tests for these amino acids in body fluids and determine whether there is a need for further diagnostics or treatment. Having established the need for further tests, the cost and risk of such further tests are justified. The invention is also useful for improving the opportunity for earlier identification of nutritionally, medically, or surgically actionable joint abnormalities.

In various embodiments, impending joint failure is diagnosed when the phenylalanine:tyrosine ratio is equal to or greater than 0.2 but equal to or less than 0.8, preferably 0.3 to 0.7, more preferably 0.4 to 0.6, preferably about 0.5.

In various embodiments, impending joint failure is diagnosed when the phenylalanine:alanine ratio is equal to or greater than 1.5 but equal to or less than 9.8, preferably 2.0 to 8.0, more preferably 4.0 to 7.0, most preferably about 5.5.

In various embodiments, impending joint failure is diagnosed when the phenylalanine:valine ratio is equal to or greater than 1.0 but equal to or less than 6.0, preferably 2.0 to 5.0, more preferably 3.0 to 4.0, most preferably about 3.5.

In various embodiments, impending joint failure is diagnosed when the phenylalanine:glutamine ratio is equal to or greater than 0.5 but equal to or less than 4.5, preferably 1.0 to 3.5, more preferably 2.0 to 3.0, most preferably about 2.5.

While the ratio of phenylalanine to any one of the other amino acids is sufficient for diagnosing impending joint failure, the use of two or more of such ratios is encompassed within the invention and may be preferred in many circumstances. In one embodiment, the diagnosis is based upon two ratios, in another three ratios, in another four ratios. The ratios can be used in any combination.

The body fluid can be any suitable body fluid that contains the required amino acids, e.g., blood, blood serum, tears, and urine. Preferably the body fluid is blood or blood serum. Most preferably, the body fluid is blood serum.

Any joint subject to failure can be diagnosed using the methods of the present invention. Typical joints include, but are not limited to, gliding joints (Arthrodia), hinge joints (Ginglymus), condyloid joints (Condylarthrosis), saddle-shaped joints (Articulus sellaris), ball and socket joints (Enarthrosis), and 6) pivot joints (Trochoides). Specific joints include, but are not limited to, knee, elbow, interphalangeal, metacarpophalangeal, wrist, carpo-metacarpal, thumb, shoulder, hip, temporo-mandibular, and radio-ulnar joints. Shoulder and hip joints are particularly susceptible to joint failure.

In various embodiments, the animal is a human or companion animal. Preferably, the companion animal is a canine such as a dog or a feline such as a cat.

Methods for determining amino acid concentration in body fluids are well known in the art. Various chemical analyzers, manual or automated, are available commercially to skilled artisans for measuring concentrations of phenylalanine, tyrosine, alanine, valine, and glutamine in body fluids, particularly blood serum.

In another aspect, the invention provides methods for determining the effect of an agent on an animal's prognosis for joint disease or failure. The methods comprise (1) diagnosing impending joint failure in an animal by measuring the concentration of phenylalanine in a body fluid; measuring the concentration of one or more of tyrosine, alanine, valine, and glutamine in the body fluid; determining the ratio of phenylalanine to one or more of tyrosine, alanine, valine, and glutamine; and diagnosing impending joint failure when at least one of the phenylalanine:tyrosine ratio is equal to or greater than 0.2 but equal to or less than 0.8, the phenylalanine:alanine ratio is equal to or greater than 1.5 but equal to or less than 9.8, the phenylalanine:valine ratio is equal to or greater than 1.0 but equal to or less than 6.0, and the phenylalanine:glutamine ratio is equal to or greater than 0.5 but equal to or less than 4.5; (2) administering the agent to the animal; (3) diagnosing impending joint failure in an animal using the method of (1); and (4) comparing the results from (1) and (3) and determining the effect of the agent on the animal's prognosis for joint disease or failure.

Generally, if the animal has a ratio of amino acids as described that is outside the given ranges and the agent modifies the ratio such that the ratio is within the given ranges, the agent has a potential to cause joint disease or failure. Conversely, if the animal has a ratio of amino acids as described that is inside the given ranges and the agent modifies the ratio such that the ratio is outside the given ranges, the agent has a potential to prevent or treat joint disease or failure.

The agent can be any substance, material, compound, or element that is suspected to have an effect on joint disease or failure. Typical agents include drugs, antibodies, pharmaceuticals, holistic formulations, enzymes, enzyme inhibitors (inhibitors of cathepsin K, cathepsin S, or tartrate-resistant acid phosphatase), creams, lotions, and the like. Specific compounds include, but are not limited to, corticosteroids, polycosanols, glucosamine, chondroitin, tetracycline compounds, non-steroidal anti-inflammatory drugs (NSAIDs), local anesthetics, Cox-2 inhibitors, chelating agents, matrix metalloprotease inhibitors, inflammatory cytokine inhibitors, collagen hydrolysates, and their mimetics. Further, agents are defined to include physical means such as physical therapy, heat therapy, massage, acupuncture, and the like.

The elapsed time between when the agent is administered to an animal and when a diagnosis of impending joint failure in an animal is made for comparison ((3) above) varies based upon the agent, the animal, dosage, test conditions, and the like. Such elapsed times are within the purview of the skilled artisan. In various embodiments, the elapsed time is from about one day to about 360 days, preferably from about 7 days to about 180 days, more preferably from about 30 days to about 90 days. In other embodiments, the elapsed time is greater than 7 days, preferably greater than 14 days, more preferably greater than 30 days.

The agents can be administered using any suitable method compatible with the agent and the animal, e.g., by physical contact or by oral, parenteral, intranasal, subcutaneous, transdermal, transmucosal, or intravenous administration.

In another aspect, the invention provides a means for communicating information about or instructions for one or more of (1) diagnosing impending joint failure in an animal based upon the ratio of phenylalanine to one or more of tyrosine, alanine, valine, and glutamine; (2) using the ratio of phenylalanine to one or more of tyrosine, alanine, valine, and glutamine for determining the effect of an agent on an animal's prognosis for joint disease or failure; and (3) contact information for consumers to use if they have a question about diagnosing impending joint failure in an animal or determining the effect of an agent on an animal's prognosis for joint disease or failure based upon the ratio of phenylalanine to one or more of tyrosine, alanine, valine, and glutamine. The means comprises one or more of a physical or electronic document, digital storage media, optical storage media, audio presentation, audiovisual display, or visual display containing the information or instructions. Preferably, the means is selected from the group consisting of a displayed website, a visual display kiosk, a brochure, a product label, a package, a package insert, an advertisement, a handout, a public announcement, an audiotape, a videotape, a DVD, a CD-ROM, a computer readable chip, a computer readable card, a computer readable disk, a USB device, a FireWire device, a computer memory, and any combination thereof.

Useful instructions include methods for sampling body fluids and preparing them for amino acid analysis, methods for determining amino acid concentration in a bodily fluid, tables and charts showing ranges for amino acids that indicate impending joint failure, and recommended procedures to analyze joints if impending joint failure is indicated, particularly to confirm the indication. The communication means is useful for instructing on the benefits of using the present invention and for providing contact information for a consumer or user of the invention to obtain help in using or interpreting the results from the invention.

In another aspect, the invention provides methods for preventing or treating joint disease or failure. The methods comprise administering to an animal a novel agent (an agent that has not previously been known to be useful for preventing or treating joint disease or failure) identified as an agent with potential to prevent or treat joint disease or failure using the methods for determining the effect of an agent on an animal's prognosis for joint disease or failure described herein.

In another aspect, the invention provides systems for diagnosing impending joint failure in an animal. The systems comprise (1) a first means for developing or receiving data relating to the concentration of phenylalanine and one or more of tyrosine, alanine, valine, and glutamine in a body fluid of an animal; (2) a second means for retaining data defining acceptable ratio values for phenylalanine to one or more of tyrosine, alanine, valine, and glutamine; (3) a third means connected to and capable of obtaining data from the first and second means and using the data to calculate the ratio of phenylalanine to one or more of tyrosine, alanine, valine, and glutamine based upon the data; and (4) a fourth means connected to and capable of displaying one or more of (a) the data from the first means; (b) the data from the second means, and (c) the calculated ratio from the third means.

In one embodiment, the second means is capable of retaining the data from the first means and the calculated ratio from the third means.

In various embodiments, the first means for receiving data is a keypad, keyboard, voice recognition device, or similar input device. In various embodiments, the first means for developing data is an analytical analyzes body fluids for amino acids and determines their concentrations in the body fluid. In a preferred embodiment, the first means is a chemical procedure or chemical analyzer, preferably an automated chemical analyzer that samples a body fluid, determines the concentration of phenylalanine and one or more of tyrosine, alanine, valine, and glutamine, and electronically communicates the results to the third means.

In one embodiment, the system comprises a programmable calculator. The calculator has a keypad for receiving data, a microprocessor for retaining data defining acceptable ratio values and a program that calculates the ratios, and a display device such as a liquid crystal display or other display device that displays one or more of the data and calculated results. In another, the system comprises a computer. The computer has a keyboard, voice recognition software, or other input device for receiving data, a microprocessor for retaining data defining acceptable ratio values and a program that calculates the ratios, and a display screen or other display device that displays one or more of the data and calculated results. In a preferred, embodiment, the computer has a storage drive for retaining data and calculated values, for possible comparison and statistical analysis as needed at anytime, e.g., a computer hard drive, USB drive, CD media, DVD Media, floppy disk, and the like.

In another aspect, the invention provides computing devices useful for diagnosing impending joint failure. The devices comprise one or more of the second, third, and fourth means of the systems of the present invention. In preferred embodiments, the device is a programmable calculator or a computer.

In another aspect, the invention provides software programs useful for diagnosing impending joint failure. The software programs comprise program code useful for accomplishing one or more of the second, third, and fourth means of the systems of the present invention.

In a further aspect, the present invention provides methods for extending the prime years of an animal's life. In one embodiment, the methods comprise diagnosing impending joint failure using the methods of the present invention and intervening to prevent or alleviate the adverse effects of joint disease. Such diagnosis and intervention extend the prime years of the animal's life by alleviating discomfort, pain, lack of mobility, and other problems associated with joint failure during the animal's prime years of life. Intervention methods include using more definitive diagnosis methods, preventing the joint disease using physical methods or treatment methods such as drugs to combat joint failure. In another embodiment, the methods comprise administering to the animal a novel agent identified as an agent with potential to prevent or treat joint disease or failure using the methods for determining the effect of an agent on an animal's prognosis for joint disease or failure of the present invention. Preventing or treating joint failure extends the prime years of the animal's life by alleviating discomfort, pain, lack of mobility, and other problems associated with joint failure during the animal's prime years of life.

In a further aspect, the present invention provides methods for promoting the health or wellness of an animal. In one embodiment, the methods comprise diagnosing impending joint failure using the methods of the present invention and intervening to promote the health or wellness of the animal. Such diagnosis and intervention promote heath and wellness in the animal by alleviating discomfort, pain, lack of mobility, and other problems associated with joint failure. Intervention methods include using more definitive diagnosis methods, preventing the joint disease using physical methods or treatment methods such as drugs to combat joint failure. In another embodiment, the methods comprise administering to the animal a novel agent identified as an agent with potential to prevent or treat joint disease or failure using the methods for determining the effect of an agent on an animal's prognosis for joint disease or failure of the present invention. Preventing or treating joint failure promotes the health or wellness of the animal by alleviating discomfort, pain, lack of mobility, and other problems associated with joint failure.

### EXAMPLES

The invention can be further illustrated by the following examples, although it will be understood that these examples are included merely for purposes of illustration and are not intended to limit the scope of the invention unless otherwise specifically indicated.

### Example 1

Dogs and Housing: Labrador retriever dogs (n=48) from 7 litters were allotted to a paired feeding experimental design (Kealy et al., 1992, 1997, 2000, 2002). Pen assignment was maintained by original pairing, with either 2 (1 pair) or 4 (2 pair) dogs per pen. Free indoor-outdoor access was available and activity was not restricted. All dogs were housed under the same environmental conditions for life, with no difference between feeding groups except for amount of food intake. Most data collection was aligned with birth anniversary, including blood samplings, radiography, and physical evaluations. Routine vaccinations and antiparasite treatments were administered by litter at the appropriate intervals. Health care was managed by an attending veterinarian. The health of all dogs was monitored daily.

Diets and Feeding Regimens: The 48 dogs were paired at age 6 weeks by gender and body weight within litter, and assigned at random to one of two feeding groups. Control-fed (CF) and diet-restricted (DR) dogs ate the same dry, extruded diet (Kealy et al., 1992, 1997, 2000, 2002). All dogs were fed individually each day. From age 8 weeks, each DR pair mate was fed a quantity equal to 75% of the amount of food that was consumed on the previous day by the respective CF counterpart. When the dogs were age 3.25 years, 2 adjustments were incorporated into the feeding protocol to prevent insidious development of obesity among all of the dogs: (a) All dogs were switched from a 27% protein puppy growth formula to a 21% protein adult formula; (b) The amount of food given to CF dogs was fed at a constant amount of 62.1 kcal metabolizable energy/kg ideal body weight. DR pair mates continued to receive 75% of the consumption of their corresponding CF pair mates.

Blood Sampling: All blood sampling was done between 0800 and 1200 hours, following an overnight fast of 16 hours. Serum was separated within 1 hour, by centrifugation at 3000 rpm for 15 minutes. Serum samples were stored at −20° C. until analyzed. Samples within litter always were processed simultaneously, with annual sampling conducted at respective birth anniversaries.

Fasting serum was collected from each dog at ages 8, 13, 18, 28, 32 and 44 weeks; ages 1.0, 1.5 and 2.0 years; and annually thereafter until death. Samples were stored at minus 20° C. until analyses were performed.

NMR Spectroscopy: Serum samples were prepared by addition of 4000, of saline containing 10% D2O into 200 μL of blood serum. ¹H NMR spectra were recorded on a Bruker DRX 600 NMR spectrometer (Bruker, Germany), operating at 600.13 MHz for ¹H. A standard one dimensional ¹H NMR spectrum with water peak presaturation was acquired for each sample using the pulse sequence (RD-90-t₁-90-tm-90-acq), where RD is a relaxation delay. Here, the inter-pulse delay t₁ was 3 μs and the mixing time tm was 100 ms. The 90° pulse was 11.5 μs. A weak irradiation field was applied at the water resonance frequency during both the mixing time and the recycle delay. A total of 64 scans with 8 dummy scans were collected into 32k data points for each spectrum with a spectral width of 9615 Hz and relaxation delay of 2 seconds. The acquisition time was 1.7 seconds and the total pulse recycle time was 3.8 seconds.

¹H NMR Spectral Processing: ¹H NMR spectra were corrected for phase and baseline distortion using XWINNMR 3.5 (Bruker). The spectra were referenced to the chemical shift of the anomeric proton resonance of α-glucose at δ 5.223. The spectra over the range δ 0.5-10.0 were digitized using a MATLAB script written in-house. The region δ 4.4-5.2 was removed to avoid the effects of imperfect water suppression.

Identification of serum biomarkers of joint failure: Supervised pattern recognition method; orthogonal projection to latent structures-discriminant analysis (OPLS-DA) was used to identify the serum biomarkers of joint failure. To model the data, the ¹H NMR serum profiles were used as the predictor variables (X) and joint-failed and non-failed joint samples as the response variables (Y). The loadings were plotted after back-transformation with the respective weight of each variable (Cloarec, O.; Dumas, M. E.; Trygg, J.; Craig, A.; Barton, R. H.; Lindon, J. C.; Nicholson, J. K.; Holmes, E. Analytical Chemistry 2005, 77, 517-526.). The variables, which were important for the discrimination between the classes, were highlighted by a color code. This allowed direct interpretation of the loadings and the variables (metabolites), responsible for the discrimination from the pseudo-NMR spectra. Coefficients were considered to be significant when greater than the critical correlation coefficient value, at the 5% (p=0.05) level.

Quantification of Serum Amino Acids: ¹H NMR serum calibration samples were normalized to the mean noise between 0.40-0.44 ppm. The amino acids in each calibration sample were directly quantified from the normalized serum ¹H NMR calibration profiles at the chemical shift values indicated in Table 1.

TABLE 1
Chemical Shift Used for Quantification of Amino Acids

| Amino Acid | Chemical Shift δ ppm |
|---|---|
| Phenylalanine | 7.34 |
| Tyrosine | 7.19 |
| Alanine | 1.48 |
| Valine | 1.05 |
| Glutamine | 2.14 |

The mean values and the standard deviations of the quantitated amino acids in the failed and non-failed calibration sample was calculated and are given in Table 2 as a guide to indicate joint failure status in Labrador retrievers.

TABLE 2
Amino Acid Ratios in Canine Serum that Serve
as Indicators of Non-Failed or Failed Joints

| | Serum Ratios | Serum Ratios |
|---|---|---|
| | Indicating | Indicating |
| Amino acid ratio | “Non-Failed” Joints | “Failed” Joints |
| phenylalanine:tyrosine | 0.7 +/− 0.1 | 0.5 +/− 0.2 |
| phenylalanine:alanine | 9.7 +/− 3.3 | 5.7 +/− 4.1 |
| phenylalanine:valine | 5.8 +/− 1.9 | 3.4 +/− 2.3 |
| phenylalanine:glutamine | 4.2 +/− 0.9 | 2.5 +/− 1.6 |

In the specification, there have been disclosed typical preferred embodiments of the invention. Although specific terms are employed, they are used in a generic and descriptive sense only and not for purposes of limitation. The scope of the invention is set forth in the claims. Obviously many modifications and variations of the invention are possible in light of the above teachings. It is therefore to be understood that within the scope of the appended claims, the invention may be practiced otherwise than as specifically described.

1. A method for diagnosing impending joint failure in an animal comprising measuring the concentration of phenylalanine in a body fluid; measuring the concentration of one or more of tyrosine, alanine, valine, and glutamine in the body fluid; determining the ratio of phenylalanine to one or more of tyrosine, alanine, valine, and glutamine; and diagnosing impending joint failure when at least one of the phenylalanine:tyrosine ratio is equal to or greater than 0.2 but equal to or less than 0.8, the phenylalanine:alanine ratio is equal to or greater than 1.5 but equal to or less than 9.8, the phenylalanine:valine ratio is equal to or greater than 1.0 but equal to or less than 6.0, and the phenylalanine:glutamine ratio is equal to or greater than 0.5 but equal to or less than 4.5.

2. The method of claim 1 wherein the phenylalanine:tyrosine ratio is equal to or greater than 0.3 but equal to or less than 0.7, the phenylalanine:alanine ratio is equal to or greater than 2.0 but equal to or less than 8.0, the phenylalanine:valine ratio is equal to or greater than 2.0 but equal to or less than 5.0, and the phenylalanine:glutamine ratio is equal to or greater than 1.0 but equal to or less than 3.5.

3. The method of claim 1 wherein the phenylalanine:tyrosine ratio is equal to or greater than 0.4 but equal to or less than 0.6, the phenylalanine:alanine ratio is equal to or greater than 4.0 but equal to or less than 7.0, the phenylalanine:valine ratio is equal to or greater than 3.0 but equal to or less than 4.0, and the phenylalanine:glutamine ratio is equal to or greater than 2.0 but equal to or less than 3.0.

4. The method of claim 1 wherein the phenylalanine:tyrosine ratio is about 0.4, the phenylalanine:alanine ratio is about 5.5, the phenylalanine:valine ratio is about 3.5, and the phenylalanine:glutamine ratio is about 2.5.

5. The method of claim 1 wherein the body fluid is blood, blood serum, tears, or urine.

6. The method of claim 1 wherein the body fluid is blood or blood serum.

7. The method of claim 1 wherein the body fluid is blood serum.

8. The method of claim 1 wherein the joint is a gliding joint, hinge joint, condyloid joint, saddle-shaped joint, ball and socket joint, or pivot joint.

9. The method of claim 1 wherein the joint is a knee, elbow, interphalangeal, metacarpophalangeal, wrist, carpo-metacarpal, thumb, shoulder, hip, temporo-mandibular, or radio-ulnar joint.

10. The method of claim 1 wherein the joint is a shoulder or hip joint.

11. The method of claim 1 wherein the animal is a human.

12. The method of claim 1 wherein the animal is a companion animal.

13. The method of claim 12 wherein the animal is a canine.

14. The method of claim 12 wherein the animal is a feline.

15. A method for determining the effect of an agent on an animal's prognosis for joint disease or failure comprising (1) diagnosing impending joint failure in an animal by measuring the concentration of phenylalanine in a body fluid; measuring the concentration of one or more of tyrosine, alanine, valine, and glutamine in the body fluid; determining the ratio of phenylalanine to one or more of tyrosine, alanine, valine, and glutamine; and diagnosing impending joint failure when at least one of the phenylalanine:tyrosine ratio is equal to or greater than 0.2 but equal to or less than 0.8, the phenylalanine:alanine ratio is equal to or greater than 1.5 but equal to or less than 9.8, the phenylalanine:valine ratio is equal to or greater than 1.0 but equal to or less than 6.0, and the phenylalanine:glutamine ratio is equal to or greater than 0.5 but equal to or less than 4.5; (2) administering the agent to the animal; (3) diagnosing impending joint failure in an animal using the method of (1); and (4) comparing the results from (1) and (3) and determining the effect of the agent on the animal's prognosis for joint disease or failure.

16. The method of claim 15 wherein the agent is administered by physical contact or by oral, parenteral, intranasal, subcutaneous, transdermal, transmucosal, or intravenous administration.

17. The method of claim 15 wherein the agent modifies the ratio such that a ratio that was outside the given ranges is within the given ranges.

18. The method of claim 15 wherein the agent modifies the ratio such that the ratio that was inside the given ranges is outside the given ranges.

19. A means for communicating information about or instructions for one or more of (1) diagnosing impending joint failure in an animal based upon the ratio of phenylalanine to one or more of tyrosine, alanine, valine, and glutamine; (2) using the ratio of phenylalanine to one or more of tyrosine, alanine, valine, and glutamine for determining the effect of an agent on an animal's prognosis for joint disease or failure; and (3) contact information for consumers to use if they have a question about diagnosing impending joint failure in an animal or determining the effect of an agent on an animal's prognosis for joint disease or failure based upon the ratio of phenylalanine to one or more of tyrosine, alanine, valine, and glutamine based upon the ratio of phenylalanine to one or more of tyrosine, alanine, valine, and glutamine, the means comprising one or more of a physical or electronic document, digital storage media, optical storage media, audio presentation, audiovisual display, or visual display containing the information or instructions.

20. The means of claim 19 selected from the group consisting of a displayed website, a visual display kiosk, a brochure, a product label, a package, a package insert, an advertisement, a handout, a public announcement, an audiotape, a videotape, a DVD, a CD-ROM, a computer readable chip, a computer readable card, a computer readable disk, a USB device, a FireWire device, a computer memory, and any combination thereof.

21. A method for preventing or treating joint disease or failure comprising administering to an animal a novel agent identified as an agent with potential to prevent or treat joint disease or failure using the methods for determining the effect of an agent on an animal's prognosis for joint disease or failure of claim 15.

22. A system for diagnosing impending joint failure in an animal comprising (1) a first means for developing or receiving data relating to the concentration of phenylalanine and one or more of tyrosine, alanine, valine, and glutamine in a body fluid of an animal; (2) a second means for retaining data defining acceptable ratio values for phenylalanine to one or more of tyrosine, alanine, valine, and glutamine; (3) a third means connected to and capable of obtaining data from the first and second means and using the data to calculate the ratio of phenylalanine to one or more of tyrosine, alanine, valine, and glutamine based upon the data; and (4) a fourth means connected to and capable of displaying one or more of (a) the data from the first means; (b) the data from the second means, and (c) the calculated ratio from the third means.

23. The system of claim 22 wherein the second means is capable of retaining the data from the first means and the calculated ratio from the third means.

24. The system of claim 22 wherein the first means is a chemical procedure or chemical analyzer.

25. The system of claim 22 wherein the first means is a chemical analyzer.

26. The system of claim 25 wherein the first means is an automated chemical analyzer.

27. A computing device useful for diagnosing impending joint failure comprising one or more of the second, third, and fourth means of the system of claim 22.

28. The computing device of claim 27 comprising a programmable calculator or a computer.

29. A software program useful for diagnosing impending joint failure comprising program code useful for accomplishing one or more of the second, third, and fourth means of the system of claim 22.

30. A method for extending the prime years of an animal's life comprising diagnosing impending joint failure using the methods of claim 1 and intervening to prevent or alleviate the adverse effects of joint disease.

31. The method of claim 30 wherein intervening comprises administering to the animal a novel agent identified as an agent with potential to prevent or treat joint disease or failure using the methods for determining the effect of an agent on an animal's prognosis for joint disease or failure of claim 15.

32. A method for promoting the health or wellness of an animal comprising diagnosing impending joint failure using the methods of claim 1 and intervening to prevent or alleviate the adverse effects of joint disease.

33. The method of claim 32 wherein intervening comprises administering to the animal a novel agent identified as an agent with potential to prevent or treat joint disease or failure using the methods for determining the effect of an agent on an animal's prognosis for joint disease or failure of claim 15.
